(19) United States
(12) Patent Application Publication
(10) Pub. No.: US 2023/0331553 A1
(43) Pub. Date: Oct. 19, 2023

(54) ANISOTROPIC NANOPARTICLES CONTAINING SEMICONDUCTOR COMPOUNDS OF GROUP III AND GROUP V ELEMENTS AND MANUFACTURING METHOD THEREFOR

(71) Applicant: POSTECH RESEARCH AND BUSINESS DEVELOPMENT FOUDATION, Pohang-si (KR)

(72) Inventors: Sungjee KIM, Pohang-si (KR); Yongju KWON, Pohang-si (KR); Gyuhyun BANG, Pohang-si (KR)

(21) Appl. No.: 18/027,447

(22) PCT Filed: Sep. 17, 2021
(86) PCT No.: PCT/KR2021/012831

§ 371 Date: Mar. 21, 2023

(30) Foreign Application Priority Data
Sep. 21, 2020 (KR) 10-2020-0121262

(51) Int. Cl. C01B 25/08

(52) U.S. Cl. CPC C01B 25/087; C01P 2004/10; C01P 2004/64; C01P 2002/77

(57) ABSTRACT

The present invention relates to anisotropic nanoparticles containing semiconductor compounds of group III and group V elements and a manufacturing method therefor and, more specifically, to anisotropic nanoparticles and a manufacturing method therefor, wherein the anisotropic nanoparticles have an irregular shape, such as a branched structure, a hyper-branched/dendrimer structure, or an aggregated structure with an irregular needle-shaped surface, in which two or more anisotropic shaped unit structures containing semiconductor compounds of group III and group V elements are combined.

### TECHNICAL FIELD

The present invention relates to anisotropic nanoparticles including a semiconductor compound of group III and group V elements, and a method for manufacturing the same, and more particularly, to anisotropic nanoparticles having an irregular shape by combining two or more unit structures having an anisotropic shape including a semiconductor compound of group III elements and group V elements, and a method for manufacturing the same.

### BACKGROUND ART

Semiconductor nanoparticles have high luminous efficiency and have excellent durability to photobleaching as compared with an organic dye material. In addition, a nanoparticle material and the size thereof are adjusted to obtain a wide range of emission wavelengths from visible light to near infrared, and in particular, the size of semiconductor nanoparticles is selectively adjusted to implement various luminous colors with narrow color purity.

Research to apply excellent optical properties of the semiconductor nanoparticles to industry and medical fields such as displays, solar batteries, and bioimaging is being actively conducted. In order to use semiconductor nanoparticles in the above fields, optical properties such as a full-width at half-maximum (FWHM), quantum efficiency, luminous blinking, and photostability may be importantly considered in a luminescence spectrum. Currently, group II-group VI semiconductor nanoparticles based on cadmium chalcogenide, which is an ionic bonding material, have excellent optical properties such as a full-width at half-maximum with narrow luminescence and high quantum efficiency, but include a toxic material, and thus, their industry-wide application is limited.

In order to overcome a biotoxic risk by heavy metal contamination, the development of semiconductor nanoparticles based on group III-group V using a non-heavy metal material has progressed. Since InP nanoparticles based on group III-group V have low biotoxicity and an emission wavelength band in a visible light region, it is emerging as a material replacing cadmium chalcogenide nanoparticles. However, when the InP nanoparticles based on group III-group V grow, the particles pass through several paths in a non-equilibrium state in the process of finding a balance point between bond enthalpy and surface energy in a crystal to obtain heterogeneous particles, and a limitation in shape adjustment is shown, and thus, there are many limitations in terms of application.

In recent years, a research result in which nanoclusters having a size of 1-2 nm which are a reaction intermediate were separated and synthesized in a semiconductor nanoparticle growth path has been reported (Chem. Mater. 2016, 28, pp. 8119-8122). Group III-group V semiconductor nanoclusters had a size of 2 nm or less, and a research result for preparing nanoclusters having a larger size using the nanoclusters has been reported (Chem. Mater. 2018, 30, 11, pp. 3623-3627).

However, in the research results reported so far, the shape of group III-group V semiconductor nanoclusters or group III-group V semiconductor nanoparticles is a spherical shape or only the shape of isotropic nanocrystalline particles has been reported. However, since group III-group V semiconductor nanoparticles having an anisotropic shape and a method for manufacturing homogeneous nanoparticles having high reproducibility for manufacturing the nanoparticles show excellent electrical, optical, mechanical, and thermal properties, they may be effectively used as compared with conventional spherical or nanocrystalline particles in the field of devices such as chemical and biological sensors, field effect transistors, and light emitting diodes.

### DISCLOSURE

### Technical Problem

In order to solve the problems of the prior art described above, an object of the present invention is to provide anisotropic nanoparticles including a semiconductor compound of group III and group V elements, and a method for manufacturing the same. More specifically, an object of the present invention is to provide anisotropic nanoparticles having a branched structure, a hyperbranched or dendritic structure, and aggregate-type anisotropic nanoparticles having an irregular needle-shaped surface by separating semiconductor compound nanoclusters including group III elements and group V elements and using the nanoclusters as a synthesis precursor, and also a method for manufacturing the same.

### Technical Solution

In one general aspect, anisotropic nanoparticles having an irregular shape by combining two or more unit structures having an anisotropic shape including a semiconductor compound are provided, wherein the semiconductor compound includes group III elements and group V elements.

According to an aspect, the unit structure may have a one-dimensional shape stretched in one direction.

According to an aspect, the anisotropic nanoparticles may have a branched structure or a hyperbranched or dendritic structure.

According to an aspect, the anisotropic nanoparticles having the branched structure may have any one or two or more selected from the group consisting of a bi-pod type, a tri-pod type, a tetra-pod type, and a penta- or higher multi-pod type.

According to an aspect, the anisotropic nanoparticles having the branched structure may have an average particle diameter of 1 to 5 nm.

According to an aspect, the anisotropic nanoparticles having the hyperbranched or dendritic structure may have an average particle diameter of 10 to 50 nm.

According to an aspect, the anisotropic nanoparticles may be an aggregate having an irregular needle-shaped surface.

According to an aspect, the anisotropic nanoparticles may be derived from nanoclusters including group III elements and group V elements.

According to an aspect, the semiconductor compound may be indium phosphide (InP).

According to an aspect, the anisotropic nanoparticles may have a zinc-blende structure.

In another general aspect, a method for manufacturing anisotropic nanoparticles includes: preparing nanoclusters including group III elements and group V elements; mixing the nanoclusters with a M¹(C2-C18 alkyl carboxyl)₃ or M¹X₃ solution to prepare a reaction solution (wherein M¹ is a group III element and X is halogen); and heating the reaction solution to perform a reaction.

According to an aspect, the preparing of nanoclusters including group III elements and group V elements may be mixing and reacting M¹(C2-C4 alkyl carboxyl)₃, a C6-C16 fatty acid, and a phosphine precursor compound to obtain nanoclusters.

According to an aspect, the preparing of a reaction solution may be mixing the nanoclusters with a M¹(C6-C16 alkyl carboxyl)₃ solution to prepare a reaction solution, and the anisotropic nanoparticles may have a branched structure.

According to an aspect, the preparing of a reaction solution may be mixing the nanoclusters with a M¹ (C2-C4 alkyl carboxyl)₃ solution to prepare a reaction solution, and the anisotropic nanoparticles may have a hyperbranched or dendritic structure.

According to an aspect, the preparing of a reaction solution may be mixing the nanoclusters with a M¹X₃ solution to prepare a reaction solution, and the anisotropic nanoparticles may be an aggregate having an irregular needle-shaped surface.

### Advantageous Effects

According to the present invention, anisotropic nanoparticles including a semiconductor compound of group III and group V elements, and a method for manufacturing the same may be provided. More specifically, according to the present invention, group III-group V semiconductor nanoclusters having a size of 2 nm or less are applied as a nanoparticle synthesis precursor and reaction conditions are designed, thereby synthesizing nanoparticles having high size uniformity and anisotropy as compared with those using a molecular precursor which is a general nanoparticle synthesis precursor. Since the anisotropic nanoparticles show excellent electrical, optical, mechanical, and thermal properties, they may be preferably applied to the field of devices such as chemical and biological sensors, field effect transistors, and light emitting diodes.

Since in the anisotropic nanoparticles having a branched structure according to the present invention, branches extending from the center of the nanoparticles serve as an antenna absorbing light, the anisotropic nanoparticles are advantageous for application to a solar battery or a photodetector, and due to their anisotropic structure, space separation between electrons and holes occurs, and thus, the anisotropic nanoparticles have unique characteristics in which Auger recombination to cause luminous efficiency reduction is suppressed.

In addition, since the nanoparticles having an aggregate shape having an irregular needle-shaped surface according to the present invention have high mobility of electrons and holes formed by light, they are advantageous for application to a solar battery or light detection. In addition, since the aggregate structure includes pores, it has structural characteristics of having a high surface area and allowing carrier and release. The characteristics as such may be industrially applied to a molecular sensor, a carrier for treatment/diagnosis, a photocatalyst, or the like.

In addition, the method for manufacturing anisotropic nanoparticles including a semiconductor compound of group III and group V elements according to the present invention may provide a branched structure or a hyperbranched or dendritic structure, and an aggregate shape having an irregular needle-shaped surface with high reproducibility without using a structure-directing agent or a post-treatment process, and thus, has high industrial usability.

### DESCRIPTION OF DRAWINGS

FIG. 1 is TEM images of InP nanoparticles having (a) a branched structure, (b) a hyperbranched/dendritic structure, and (c) an aggregate structure.

FIG. 2 is absorption spectra from 0 minutes to 30 minutes at (a) 110 to 220° C. and (b) 220° C. in a process of raising a temperature to 220° C. after mixing 386-InP MSCs and 56 equivalents of In(My)₃ at room temperature for synthesizing InP nanoparticles having a branched structure.

FIG. 3 is (a) an XRD image and (b) a TEM image of a sample (˜2 nm NPs) which was synthesized when a temperature reached 220° C. after mixing 386-InP MSCs and 56 equivalents of In(My)₃ at room temperature for synthesizing InP nanoparticles having a branched structure.

FIG. 4 is TEM images of samples synthesized at (a) 30 seconds, (b) 45 seconds, (c) 90 seconds, (d) 5 minutes, (e) 10 minutes, and (f) 30 minutes after raising a temperature to 220° C. after mixing 386-InP MSCs and 56 equivalents of In(My)₃ at room temperature for synthesizing InP nanoparticles having a branched structure.

FIG. 5 is a schematic diagram of growth process of InP nanoparticles having a branched structure.

FIG. 6 is TEM images at (a) low magnification and (b) high magnification obtained after selecting and separating samples by size, the sample being reacted for 20 minutes after raising a temperature to 220° C. after mixing 386-InP MSCs and 56 equivalents of In(My)₃ at room temperature for synthesizing InP nanoparticles having a branched structure.

FIG. 7 is an XRD spectrum of 386-InP MSCs and InP nanoparticles having a branched structure (InP BNSc).

FIG. 8 is an absorption spectrum of a process of raising a temperature to 220° C. after mixing 386-InP MSCs and 112 equivalents of In(Ac)₃ at room temperature for synthesizing InP nanoparticles having a hyperbranched/dendritic structure.

FIG. 9 is TEM images of samples at (a) 210° C. and (b) 220° C. in a process of raising a temperature to 220° C. after mixing 386-InP MSCs and 112 equivalents of In(Ac)₃ at room temperature for synthesizing InP nanoparticles having a hyperbranched/dendritic structure.

FIG. 10 is an XRD spectrum of InP nanoparticles having a hyperbranched/dendritic structure (InP HBNSs and DLNSs).

FIG. 11 is TEM images of samples obtained when a total precursor concentration was (a) a high concentration (0.66 mM 386-InP MSCs, 74 mM In(Ac)₃) and (b) a low concentration (0.44 mM 386-InP MSCs, 50 mM In(Ac)₃) for synthesizing InP nanoparticles having a hyperbranched/dendritic structure.

FIG. 12 is an absorption spectrum of a growth process of InP nanoparticles having an aggregate structure.

FIG. 13 is TEM images of a growth process of InP nanoparticles having an aggregate structure.

FIG. 14 is HR-TEM images showing a lattice structure of InP nanoparticles having an aggregate structure.

FIG. 15 is (a) a HAADF-STEM image, and TEM images at tilting angles of (b) −20°, (c) −10°, (d) 0°, (e) 10°, and (f) 20°, of InP nanoparticles having an aggregate structure.

FIG. 16 is (a) a BET spectrum of InP nanoparticles having an aggregate structure (InP TANSs) and InP nanoparticles, and (b) a graph showing a hole size of InP nanoparticles having an aggregate structure based on a BJH plot.

FIG. 17 is an XRD spectrum of InP nanoparticles having an aggregate structure.

FIG. 18 is single domain size determined by Gaussian fitting and a Scherrer's equation from the XRD spectrum of InP nanoparticles having an aggregate structure.

FIG. 19 is TEM images of samples synthesized under conditions of (a) 2×, (b) 1×, and (c) 0.5× of a total precursor concentration by adjusting the amount of ODE as a solvent in synthesizing InP nanoparticles having an aggregate structure.

### BEST MODE

Hereinafter, referring to accompanying drawings, anisotropic nanoparticles including a semiconductor compound of group III and group V elements according to the present invention and a method for manufacturing the same will be described in detail. The drawings to be provided below are provided by way of example so that the spirit of the present invention can be sufficiently transferred to a person skilled in the art to which the present invention pertains.

Therefore, the present invention is not limited to the drawings provided below but may be embodied in many different forms, and the drawings suggested below may be exaggerated in order to clear the spirit of the present invention. Technical terms and scientific terms used herein have the general meaning understood by those skilled in the art to which the present invention pertains unless otherwise defined, and a description for the known function and configuration which may unnecessarily obscure the gist of the present invention will be omitted in the following description and the accompanying drawings.

In addition, the singular form used in the specification and claims appended thereto may be intended to also include a plural form, unless otherwise indicated in the context.

In the present specification and the appended claims, terms such as “first” and “second” are not used in a limited meaning but used for the purpose of distinguishing one constitutional element from other constitutional elements.

In the present specification and the appended claims, the terms such as “comprise” or “have” mean that there is a characteristic or a constitutional element described in the specification, and as long as it is not particularly limited, a possibility of adding one or more other characteristics or constitutional elements is not excluded in advance.

In the present specification and the attached claims, a nanocluster is used with the same meaning as a superatom or a magic-size cluster (MSC).

A synthesis method for precisely adjusting the structure or the shape of semiconductor nanoparticles has been continuously studied, but spherical particles or nanocrystalline particles having a crystal plane have been mainly synthesized. Semiconductor nanoparticles having a large aspect ratio such as nanorods and nanoplate-like particles and the like have been developed, but a study in which anisotropic nanoparticles having excellent optical and electrical properties are synthesized with high reproducibility has not been reported. In particular, many studies for adjusting the structure or the shape of group II-group IV semiconductor nanoparticles were conducted, but only a few studies for implementing the anisotropy of group III-V semiconductor nanoparticles have been reported. The reason is that since group III-group V semiconductor has stronger covalent bonding properties than group II-group VI semiconductor, it has a more gentle contrast between crystal planes different from each other, and the synthesis of generally spherical particles or nanocrystalline particles having a crystal plane is preferred.

For this reason, a method of using a structure-directing agent or a post-treatment process for implementing anisotropy in the group III-group V semiconductor nanoparticles may be considered, but anisotropic group III-group V semiconductor nanoparticles such as InP, InAs, and GaAs have not been reported to date. The present applicant found that anisotropic group III-group V semiconductor nanoparticles having high size uniformity may be synthesized with high reproducibility, by applying group III-group V semiconductor nanoclusters as a nanoparticle synthesis precursor and designing reaction conditions, without using a structure-directing agent or a post-treatment process.

In addition, in the process of studying the technology in more depth, it was confirmed that a branched structure or a dendritic structure and an aggregate shape having an irregular needle-shaped surface may be freely adjusted during a reaction with group III-group V semiconductor nanoclusters depending on a specific reactant, and thus, the present invention has been completed.

The anisotropic nanoparticles according to the present invention are anisotropic nanoparticles having an irregular shape by combining two or more unit structures having an anisotropic shape including a semiconductor compound, wherein the semiconductor compound includes group III elements and group V elements.

The unit structure having an anisotropic shape forms anisotropic nanoparticles, and has a one-dimensional shape stretched in one direction.

Usually, a material having structural properties may be classified into three-dimensional (3D), two-dimensional (2D), one-dimensional (1D), and 0-dimensional (0D) materials depending on the number of dimensions. In particular, in the case of a material which has crystallographic properties and thus, different optical and electrical properties, even materials having the same elements have different bonding properties between atoms with the different number of dimensions, and thus, the materials may have greatly different material properties. In particular, as compared with a nanostructure having an isotropic shape, a nanostructure having an anisotropic shape shows different electrical, optical, mechanical, and thermal properties, and thus, it may be preferred that a unit structure has anisotropy in order for nanoparticles to implement anisotropy.

A one-dimensional shape refers to a linear shape, and may refer to a shape such as a nanorod, a nanoneedle, a nanotube, or a nanowire, and preferably may be a nanorod shape. Since the unit structure is stretched in one direction, its aspect ratio is more than 1, and specifically, 1.5 or more, 2 or more, or 5 or more, and unlimitedly 100 or less.

Two or more unit structures having an anisotropic shape are combined with each other to form anisotropic nanoparticles, but, as a preferred embodiment, may be combined with each other in a direction different from the stretched direction of one unit structure. Accordingly, the anisotropic nanoparticles may have a branched structure or a hyperbranched structure/dendritic structure.

The anisotropic nanoparticles having the branched structure may have any one or two or more selected from the group consisting of a bi-pod type, a tri-pod type, a tetra-pod type, and a penta- or higher multi-pod. The number of branches may be 8 or less without limitation. Preferably, the anisotropic nanoparticles may be bi-pod type anisotropic nanoparticles having two branches, tri-pod type anisotropic nanoparticles having three branches, and tetra-pod type anisotropic nanoparticles having four branches.

The anisotropic nanoparticles having the branched structure may have an average particle diameter of 1 to 5 nm, specifically 2 to 4 nm.

The anisotropic nanoparticles having a hyperbranched structure or dendritic structure according to an embodiment refer to a structure including a plurality of branches in one particle by combining a plurality of unit structures. The number of branches may be specifically 10 or more and unlimitedly 100 or less. In the hyperbranched structure or dendritic structure, a plurality of unit structure are bonded to one end of one unit structures and, again, a plurality of unit structures are bonded to one end of each unit structure, thereby forming a structure in which a branch-like regular unit structure is repeatedly extended from a core. Accordingly, the anisotropic nanoparticles having the hyperbranched structure or dendritic structure may have an average particle diameter of 10 to 100 nm, specifically 10 to 50 nm, and more specifically 15 to 25 nm.

The anisotropic nanoparticles according to an exemplary embodiment may have an aggregate structure having an irregular needle-shaped surface. The aggregate structure has an entirely spherical shape in which a branched structure, a hyperbranched structure/dendritic structure, and the like are aggregated and combined with an irregular shape, and its surface is an irregular needle-shaped surface.

In the present specification, the term “spherical” shape or other synonyms thereof refer to a substantially round-ball geometry. The term is used for representing a non-elongated shape, not a shape elongated in one direction, of nanoparticles, and means that the entire shape of particles observed by an electron microscope is spherical, but the shape does not need to be completely spherical.

The anisotropic nanoparticles having the aggregate structure may have an average particle diameter of 10 to 100 nm, specifically 10 to 50 nm, and more specifically 15 to 25 nm. The anisotropic nanoparticles having the aggregate structure may include pores, and may include pore properties of 10 to 500 cc/mg. The pores may have an average radius of 1 to 5 nm, specifically 1 to 3 nm.

Preferably, the anisotropic nanoparticles are derived from nanoclusters including group III elements and group V elements. Though the nanocluster is not a most thermodynamically stable form, it refers to a kinetically stable intermediate obtained in a synthesis process. Without limitation, the sum of group III elements and group V elements included in the nanoclusters may be 20 to 100, specifically 30 to 70. The nanocluster is not formed of only group III elements and group V elements, and has a form to which a ligand such as alkyl carboxyl, alkenyl carboxyl, alkyl carbonyl, alkenyl carbonyl, alkyloxy, alkenyloxy, or aryloxy is bonded.

Specifically, the nanocluster including group III element and group V element may be represented by the following Chemical Formula 1:

M¹ₓM²_{y}L_{z} [Chemical Formula 1]

wherein x is an integer of 20 to 60, y is an integer of 10 to 30, z is an integer of 10 to 100, M¹ is a group III element, M² is a group V element, and L is a ligand of alkyl carboxyl, alkenyl carboxyl, alkyl carbonyl, alkenyl carbonyl, alkyloxy, alkenyloxy, or aryloxy.

More specifically, L may be a ligand of C2-C20 alkyl carboxyl, C2-C20 alkenyl carboxyl, C2-C20 alkyl carbonyl, C2-C20 alkenyl carbonyl, C1-C20 alkyloxy, C1-C20 alkenyloxy, or C6-C20 aryloxy, and more specifically, L may be a ligand of C10-C20 alkyl carboxyl, C10-C20 alkenyl carboxyl, C10-C20 alkyl carbonyl, C10-C20 alkenyl carbonyl, C10-C20 alkyloxy, C10-C20 alkenyloxy, or C6-C12 aryloxy.

It is considered that the nanocluster may be decomposed into a fragment and a monomer in the process of reaction, and the decomposed material forms spherical amorphous nanoparticles, which are combined with seeds present in the solution, thereby forming nanoparticles having a branched structure or a hyperbranched or dendritic structure. Here, in the fragmentation of the nanocluster, the alkyl carboxyl compound of group III elements and a fatty acid may accelerate or delay the fragmentation reaction. Illustratively, the use of a C6-C16 fatty acid and a C6-C16 alkyl carboxyl compound of group III elements in combination may derive the production of anisotropic nanoparticles very effectively while accelerating or delaying the fragmentation reaction, and thus, is preferred.

The anisotropic nanoparticles synthesized by the reaction may have a thermodynamically stable zinc-blende structure. As described above, the spherical nanoparticles decomposed from the nanoclusters have amorphous characteristics, but are combined with seeds present in the solution to form a branched structure and also converted into a zinc-blended structure.

The anisotropic nanoparticles including group III elements and group V elements according to an exemplary embodiment may be semiconductor nanoparticles such as InP, InAs, and GaAs, and preferably, may be InP semiconductor nanoparticles.

In addition, the present invention provides a method for manufacturing anisotropic nanoparticles, and the method includes: preparing nanoclusters including group III elements and group V elements; mixing the nanoclusters with a M¹(C2-C18 alkyl carboxyl)₃ or M¹X₃ solution to prepare a reaction solution; and heating the reaction solution to perform a reaction. Herein, M¹ is a group III element and X is halogen.

The preparing of a nanocluster including group III elements and group V elements may be mixing and reacting M¹(C2-C4 alkyl carboxyl)₃, a C6-C16 fatty acid, and a phosphine precursor compound to obtain nanoclusters. Here, the phosphine precursor compound may be a tris(trialkylsilyl)phosphine compound, in which the alkyl group may be a C1-C4 alkyl group. A specific example thereof may be tris(trimethylsilyl)phosphine, tris(triethylsilyl)phosphine, and tris(tripropylsilyl)phosphine.

A mole ratio between M¹(C2-C4 alkyl carboxyl)₃ and the phosphine precursor compound may be 1:0.1 to 1:10, specifically 1:0.1 to 1:2, and more specifically 1:0.2 to 0.8. In addition, a mole ratio between M¹(C2-C4 alkyl carboxyl)₃ and the C6-C16 fatty acid may be 1:1 to 1:10, specifically 1:2 to 1:5.

The reaction solvent may be an aliphatic solvent, or C10-C30 aliphatic solvent. Specifically, it may be a C10-C30 alkene-based solvent, more specifically a C12-C20 alkene-based solvent.

The metal M¹ of M¹(C2-C4 alkyl carboxyl)₃ refers to group 3 elements such as Al, Ga, and In, and specifically, may be In(Ac)₃. The C6-C16 fatty acid is a long chain fatty acid, specifically a myristic acid.

A reaction temperature may be in a range of 70 to 170° C., and the reaction may be performed under an inert gas atmosphere.

As a non-limiting and specific example, the nanocluster may be In₃₇P₂₀ (O₂CR)₅₁ (R═C13 alkyl), and the reactant for synthesizing the nanocluster may be In(Ac)₃, myristic acid, and tris(trimethylsilyl)phosphine.

Various forms of anisotropic nanoparticles may be manufactured depending on the composition of the reaction solution prepared by mixing a M¹(C2-C18 alkyl carboxyl)₃ or M¹X₃ solution with the nanoclusters.

According to an embodiment, for manufacturing the anisotropic nanoparticles having a branched structure, a step of mixing a M¹(C6-C16 alkyl carboxyl)₃ solution to prepare a reaction solution and heating the solution is included. The C6-C16 alkyl carboxyl compound included in M¹(C6-C16 alkyl carboxyl)₃ may be preferably the same material as the C6-C16 fatty acid used in the synthesis of the nanoclusters.

The reaction temperature of the nanoclusters and M¹(C6-C16 alkyl carboxyl)₃ may be 150 to 300° C., specifically 180 to 250° C.

After completing the reaction, a purification process may be included, and the anisotropic nanoparticles may be separated and purified by a known purification means. Illustratively, a sample is mixed in a mixed solvent of an aromatic solvent and alcohol and a purification process may be performed by centrifugation.

According to an embodiment, for manufacturing the anisotropic nanoparticles having a hyperbranched or dendritic structure, a step of mixing M¹(C2-C4 alkyl carboxyl)₃ solution to prepare a reaction solution and heating the solution is included. A specific example of M¹(C2-C4 alkyl carboxyl)₃ may be In(Ac)₃. The reaction temperature and the purification process may be the same as those of the branched structure, and the detailed description thereof will be omitted.

According to an embodiment, for manufacturing the anisotropic nanoparticles having an aggregate type structure having an irregular needle-shaped surface, a step of mixing a M¹X₃ solution to prepare a reaction solution and heating the solution is included. A specific example of M¹X₃ may be InCl₃. The reaction temperature and the purification process may be the same as those of the branched structure, and the detailed description thereof will be omitted.

Hereinafter, the present invention will be described in detail by the following examples. The following examples described below are only to assist in the understanding of the present invention, and the present invention is not limited to the following examples.

### [Example 1] Synthesis of InP Nanoparticles Having Branched Structure

InP nanoparticles having a branched structure were manufactured by four steps of (1) synthesizing 386-InP nanoclusters (MSCs), (2) preparing In(My)₃, (3) reacting 386-InP MSCs and In(My)₃, and (4) size-selectively purifying, using In(Ac)₃, myristic acid (HMy), and tris(trimethylsilyl)phosphine (TMS3P).

(1) Synthesis of 386-InP MSCs: In order to synthesize 386-InP MSCs which were nanoclusters having a maximum absorption wavelength at 386 nm, 0.8 mmol of In(Ac)₃, 2.9 mmol of myristic acid, and 20 mL of a 1-octadecene solvent were mixed, 0.4 mmol of tris(trimethylsilyl)phosphine precursor was injected thereinto at 110° C. to perform a reaction for 2 hours in a nitrogen environment, and then the reaction was completed. For more detailed synthesis conditions, Dylan C. Gary et al., J. Am. Chem. Soc. 2016, 138, pp. 1510-1513 may be referred.

(2) Preparation of In (My)₃ solution: 0.3 mmol of In(Ac)₃ and 0.9 mmol of a myristic acid precursor were dispersed in 4 mL of a 1-octadecene (ODE) solvent, the reaction solution was heated with stirring at 110° C. for 2 hours in a vacuum state, and the temperature was lowered to room temperature.

(3) Reaction of 386-InP MSCs and In(My)₃: 8 mL of the 386-InP MSCs solution synthesized in (1) was mixed with 4 mL of the In(My)₃ solution of (2) at room temperature, and the temperature was raised to 220° C. in a nitrogen environment. After the temperature reached 220° C., the reaction was performed for 20 minutes and was completed.

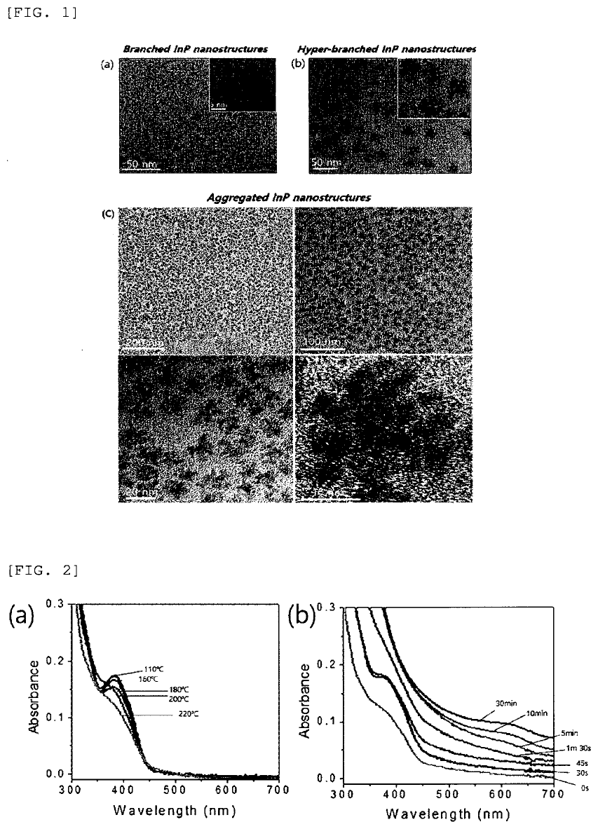

(4) Size-selective purification: 1 mL of the sample synthesized in (3), 9 mL of toluene, and 4 mL of methanol were mixed and purified by centrifugation. The centrifugation purification was performed under the conditions of 3000 rpm for 3 minutes. The InP nanoparticles having a branched structure obtained by the purification are shown in (a) of FIG. 1.

### [Example 2] Analysis of Growth Process of InP Nanoparticles Having Branched Structure

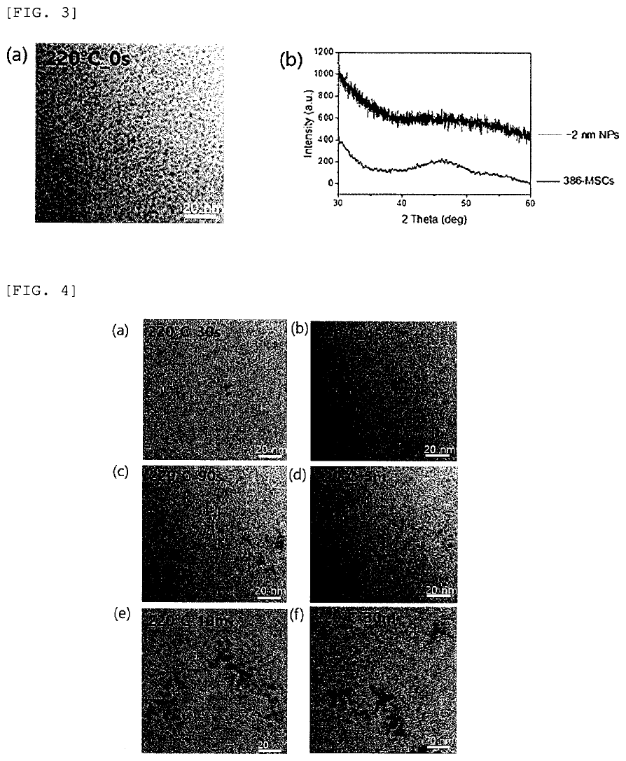

The optical properties and the shape properties of the growth process of the InP nanoparticles having a branched structure were analyzed. Referring to (a) of FIG. 2, in the process of raising the temperature from room temperature to 220° C. after mixing 386-InP MSCs and an In(My)₃ precursor, a characteristic absorption peak of 386-InP MSCs at 110° C. was observed at 386 nm, and then when heating to 220° C. was performed, an absorption was decreased and 386-InP MSCs disappeared. When the temperature reached 220° C., particles having a diameter of about 2 nm were formed as shown in (a) of FIG. 3, and as a result of XRD analysis of (b) of FIG. 3, it was found that the particles were close to amorphous.

After amorphous clusters having a diameter of about 2 nm were formed, the reaction was continued at 220° C., and then regular tetrahedron-shaped seeds formed in the samples synthesized at 30 seconds and 45 seconds, as shown in (a) and (b) of FIG. 4. Thereafter, as shown in (c), (d), (e), and (f) of FIG. 4, it was confirmed that branches grew from the seeds, and as shown in (b) of FIG. 2, a characteristic of absorbing up to a long wavelength of about 700 nm was shown.

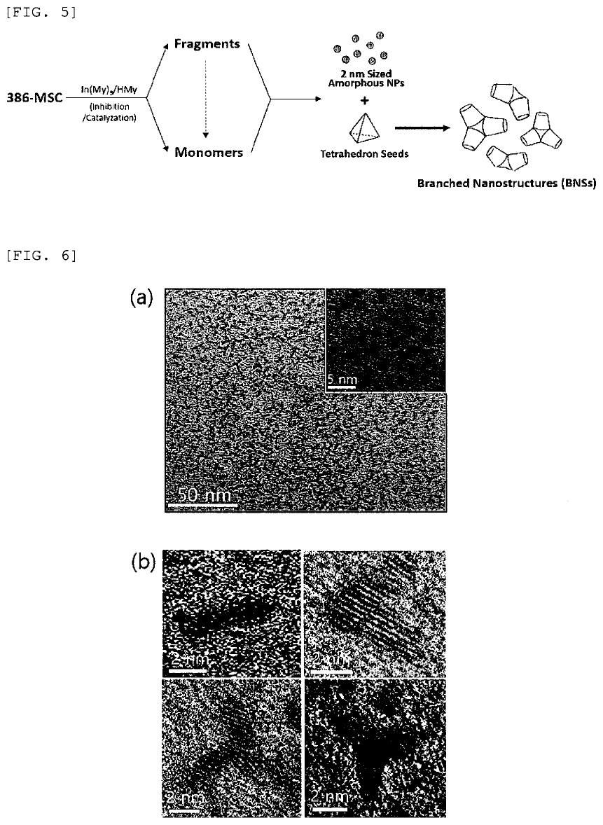

FIG. 5 is a schematic diagram showing a process by which InP nanoparticles having a branched structure grew from 386-InP MSCs. Initial 386-InP MSCs were converted upon heating into fragments and monomers by fragmentation, seeds of amorphous cluster having a size of 2 nm and InP nanoparticles having a branched structure were formed therefrom, and branches grew by junction of fragments or amorphous clusters from the seeds.

### [Example 3] Analysis of Shape and Structure of InP Nanoparticles Having Branched Structure

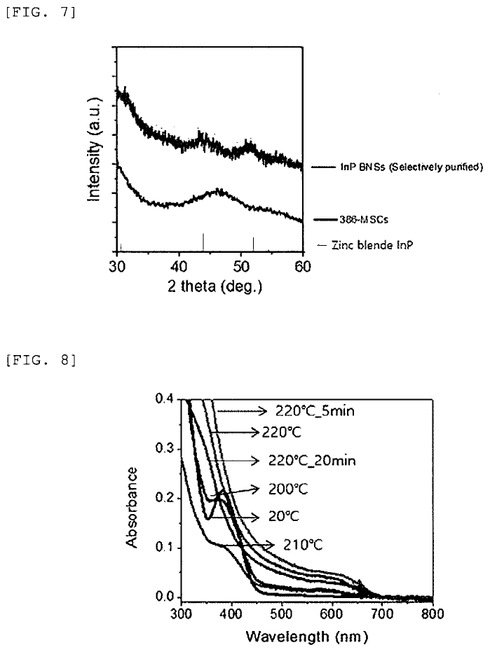

A final product synthesized by the reaction of 386-InP MSCs and an In(My)₃ precursor was a mixture of 2 nm amorphous clusters and InP nanoparticles having a branched structure. The InP nanoparticles having a branched structure were separated therefrom by size-selective purification and the shape and the structure were analyzed. As a result of observation at an ensemble level of InP nanoparticles having a branched structure by TEM, it was shown that the length and the number of branches were various, as shown in (a) of FIG. 6. As a result of high resolution-transmission electron microscopy observation, the particles were formed of mono-pods having one branch, bipods having two branches, tripods having three branches, tetra-pods having four branches, and the like, as shown in (b) of FIG. 6. FIG. 7 shows that the InP nanoparticles having a branched structure synthesized had a zinc-blende structure, as a result of XRD measurement.

### [Example 4] Synthesis of InP Nanoparticle Having Hyperbranched or Dendritic Structure

InP nanoparticles having a hyperbranched or dendritic structure were manufactured by four steps of (1) synthesizing 386-InP MSCs, (2) preparing an In(Ac)₃ solution, (3) reacting 386-InP MSCs and In(Ac)₃, and (4) performing size-selective purification, using In(Ac)₃, myristic acid, and tris(trimethylsilyl)phosphine. Among them, since steps (1) and (4) were the same as Example 1, the description thereof will be omitted, and steps (2) and (3) will be described as follows:

(2) Preparation of In(Ac)₃ solution: 0.6 mmol of an In(Ac)₃ precursor was dispersed in 4 mL of a 1-octadecene (ODE) solvent, the reaction solution was heated with stirring at 110° C. for 2 hours in a vacuum state, and the temperature was lowered to room temperature.

(3) Reaction of 386-InP MSCs and In(Ac)₃: 8 mL of the 386-InP MSCs solution synthesized in (1) was mixed with 4 mL of the In(Ac)₃ solution of (2) at room temperature, and the temperature was raised to 220° C. in a nitrogen environment. After the temperature reached 220° C., the reaction was performed for 20 minutes and was completed.

### [Example 5] Analysis of Growth Process of InP Nanoparticle Having Hyperbranched or Dendritic Structure

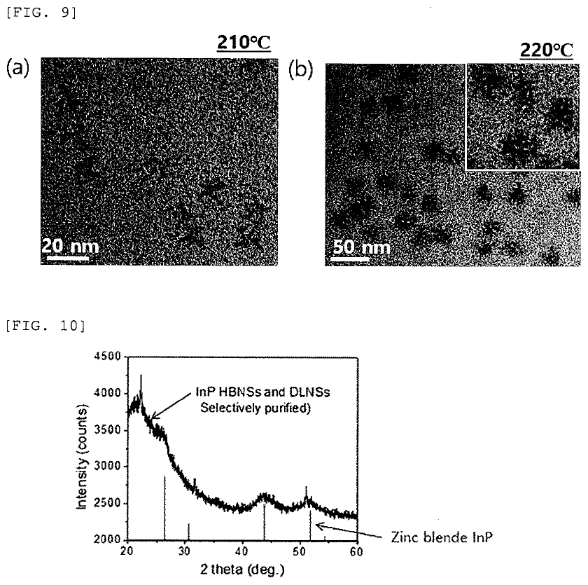

The optical properties and the shape properties of the growth process of the InP nanoparticles having a hyperbranched or dendritic structure were analyzed. In the process of raising the temperature from room temperature to 220° C. after mixing 386-InP MSCs and an In(Ac)₃ precursor, as shown in FIG. 8, a characteristic absorption peak of 386-InP MSCs at room temperature was observed at 386 nm, and then when heating to 210° C. was performed, an absorption was decreased and 386-InP MSCs disappeared. At this time, a material absorbing up to a long wavelength of about 700 nm was formed, and as a result of TEM observation, as shown in (a) of FIG. 9, it was shown that InP nanoparticles having a branched structure were first formed. When the temperature reached 220° C., as shown in (b) of FIG. 9, an absorption of a long wavelength of about 700 nm was increased and finally InP nanoparticles having a hyperbranched or dendritic structure were formed.

### [Example 6] Analysis of Shape and Structure of InP Nanoparticles Having Hyperbranched or Dendritic Structure

A final product synthesized by the reaction of 386-InP MSCs and an In(Ac)₃ precursor was a mixture of 2 nm amorphous clusters and InP nanoparticles having a hyperbranched or dendritic structure. The InP nanoparticles having a hyperbranched or dendritic structure were separated therefrom by size-selective purification and the shape and the structure were analyzed. The InP nanoparticles having a hyperbranched or dendritic structure were uniformly distributed at a size of about 20 nm as shown in (b) of FIG. 9. FIG. 10 shows that the InP nanoparticles having a hyperbranched (InP HBNSs) or dendritic structure (InP DLNSs) synthesized had a zinc-blende structure, as a result of XRD measurement.

### [Example 7] Size Adjustment of InP Nanoparticles Having a Hyperbranched or Dendritic Structure

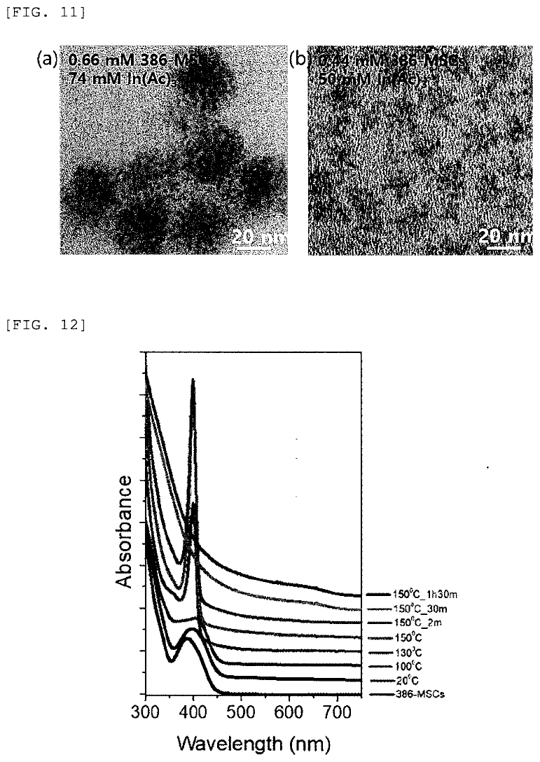

FIG. 11 shows that when a total precursor concentration was changed in the reaction of 386-InP MSCs and an In(Ac)₃ precursor, the size of InP nanoparticles having a hyperbranched or dendritic structure was adjusted. When the total precursor was under high concentration conditions (0.66 mM 386-InP MSCs, 74 mM In(Ac)₃), the nanoparticles having a hyperbranched or dendritic structure had a size of 30-40 nm. When the total precursor was under low concentration conditions (0.44 mM 386-InP MSCs, 50 mM In(Ac)₃), the nanoparticles having a hyperbranched or dendritic structure had an average size of 20 nm. Since a larger size was formed under high concentration conditions, it was presumed to be a growth mechanism of a hyperbranched or dendritic structure by aggregation of initially formed nanoparticles having a branched structure.

### [Example 8] Synthesis of InP Nanoparticles Having Aggregate Structure

InP nanoparticles having an aggregate structure were manufactured by three steps of (1) synthesizing 386-InP MSCs, (2) preparing an InCl₃ solution, and (3) reacting 386-InP MSCs and InCl₃, using (In(Ac)₃), InCl₃, myristic acid (HMy), and tris(trimethylsilyl)phosphine (TMS3P). Among them, since step (1) was the same as Example 1, the description thereof will be omitted, and steps (2) and (3) will be described as follows:

(2) Preparation of InCl₃ solution: 0.4 mmol of an InCl₃ precursor was dispersed in 4 mL of a 1-octadecene (ODE) solvent, the reaction solution was heated with stirring at 110° C. for 2 hours in a vacuum state, and the temperature was lowered to room temperature.

(3) Reaction of 386-InP MSCs and InCl₃: 8 mL of the 386-InP MSCs solution synthesized in (1) was mixed with 4 mL of the InCl₃ solution of (2) at room temperature, and then the reaction was performed for 2 hours in a vacuum environment. Thereafter, the temperature was raised up to 150° C., and the reaction was completed after 1 hour and 30 minutes. At this time, the finally synthesized sample was InP nanoparticles having an aggregate structure, as shown in (c) of FIG. 1.

### [Example 9] Analysis of Growth Process of InP Nanoparticles Having Aggregate Structure

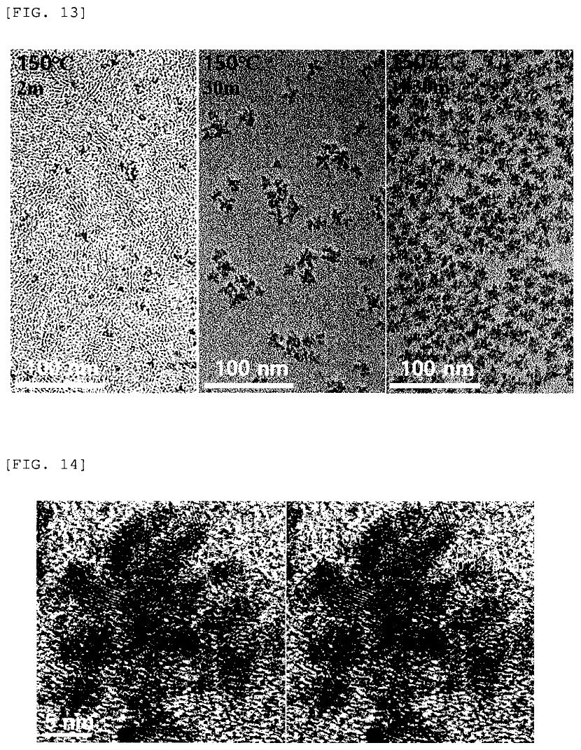

As shown in FIG. 12, the optical properties and the shape properties of the process by which InP nanoparticles having an aggregate structure grew were analyzed. In the process of heating from room temperature to 150° C. after mixing 386-InP MSCs and an InCl₃ precursor, a characteristic absorption band of 386-InP MSCs used as an initial precursor disappeared at 130° C. and a characteristic absorption band was shown at 399 nm. At this time, the intermediate having a characteristic absorption band at 399 nm was F399-InP:Cl MSCs (MSC family of InP material having a characteristic absorption band at 399 nm and including Cl). It was observed up to 2 minutes after F399-InP:Cl MSCs reached 150° C. At this time, a material absorbing up to a long wavelength near about 600 nm was also formed. As a result of observing a TEM image, as shown in FIG. 13, nanoparticles having a diameter of 3-4 nm and a shape of F399-InP:Cl MSCs having a size of about 2 nm aligned in one dimension were formed. After performing the reaction at 150° C. for 30 minutes, F399-InP:Cl MSCs all disappeared, and nanoparticles having a diameter of 3-4 nm started to be non-uniformly aggregated (FIGS. 12 and 13). After performing the reaction at 150° C. for 1 hour and 30 minutes, all nanoparticles were uniformly aggregated to finally synthesize InP nanoparticles having an aggregate structure (see FIGS. 12 and 13). Initially formed seeds were uniformly aggregated under the corresponding experiment conditions.

### [Example 10] Analysis of Shape and Structure of InP Nanoparticles Having Aggregate Structure

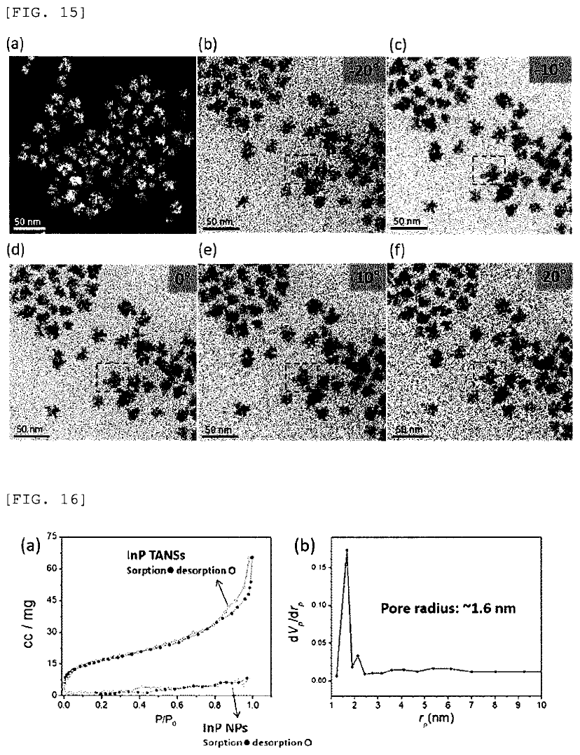

The shape and the structure of InP nanoparticles having an aggregate structure which was the final product synthesized by the reaction of 386-InP MSCs and an InCl₃ precursor were analyzed. Referring to (c) of FIG. 1, the InP nanoparticles having an aggregate structure were uniform with a size of about 20 nm at an ensemble level. Referring to FIG. 14, as a result of high resolution-transmission electron microscopy (HR-TEM) observation, the nanoparticles having an aggregate structure had partially fused crystal lattices. Thus, poly-crystalline characteristics were found therefrom, and it was presumed that fusion occurred partially after aggregation. A crystal lattice spacing was about 0.33 mm, which corresponds to a spacing between (111) InP crystal planes. Referring to FIG. 15, the three-dimensional aggregate structure was able to be observed by a high angle annular dark field-scanning transmission electron microscopic (HAADF-STEM) image and a TEM tilting image.

Pores were observed in the inside of the nanoparticles having an aggregate structure (InP TANSs), and the nanoparticles had porous properties. The porous properties were confirmed by comparison with a control group of InP nanoparticles (INP NPs) having no pore by the Brunauer-Emmett-Teller (BET) experiment. As shown in (a) of FIG. 16, the nanoparticles showed porous properties of about 60 cc/mg. Referring to (b) of FIG. 16, the pore size was found to be an average radius of 1.6 nm as a result of calculating the Barrett-Joyner-Halenda (BJH) equation.

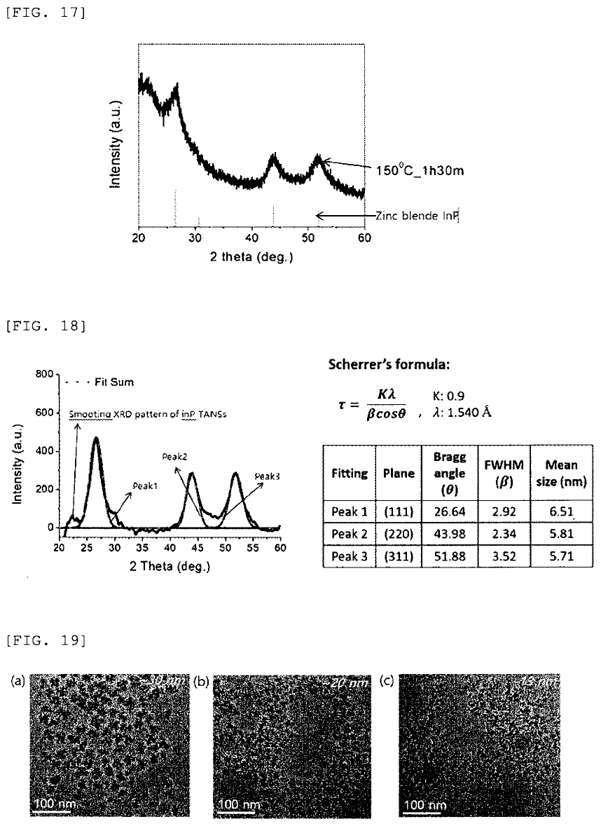

Referring to FIG. 17, the InP nanoparticles having an aggregate structure corresponded to a zinc-blende structure, as a result of XRD measurement. An average size of a single crystalline domain of the InP nanoparticles having an aggregate structure having polycrystalline properties was found to be about 5.7 nm, as a result of calculation by the Scherrer's equation and the XRD pattern (see FIG. 18).

### [Example 11] Adjustment of Size of InP Nanoparticles Having Aggregate Structure

Referring to FIG. 19, when a total precursor concentration was changed in the reaction of 386-InP MSCs and an InCl₃ precursor, the size of the InP nanoparticles having an aggregate structure was able to be adjusted. When the total concentration of the precursor was the conditions of 0.88 mM 386-InP MSCs and 100 mM InCl₃, the particles were aggregated to those having a diameter of about 20 nm, and when the total precursor concentration was two times higher, the particles were aggregated to those having a diameter of about 30 nm, and when the total precursor concentration was 0.5 times lower, aggregated to those having a diameter of about 13 nm. Since a larger size was formed under high concentration conditions, it was presumed to be a growth mechanism of an aggregate structure by aggregation of initially formed seed nanoparticles.

1. Anisotropic nanoparticles having an irregular shape by combining two or more unit structures having an anisotropic shape including a semiconductor compound,
wherein the semiconductor compound includes group III elements and group V elements.

2. The anisotropic nanoparticles of claim 1, wherein the unit structure has a one-dimensional shape stretched in one direction.

3. The anisotropic nanoparticles of claim 1, wherein the anisotropic nanoparticles have a branched structure or a hyperbranched or dendritic structure.

4. The anisotropic nanoparticles of claim 3, wherein the anisotropic nanoparticles having the branched structure have any one or two or more selected from the group consisting of a bi-pod type, a tri-pod type, a tetra-pod type, and a penta- or higher multi-pod type.

5. The anisotropic nanoparticles of claim 4, wherein the anisotropic nanoparticles having the branched structure have an average particle diameter of 1 to 5 nm.

6. The anisotropic nanoparticles of claim 3, wherein the anisotropic nanoparticles having the hyperbranched or dendritic structure have an average particle diameter of 10 to 50 nm.

7. The anisotropic nanoparticles of claim 1, wherein the anisotropic nanoparticles are an aggregate having an irregular needle-shaped surface.

8. The anisotropic nanoparticles of claim 1, wherein the anisotropic nanoparticles are derived from nanoclusters including group III elements and group V elements.

9. The anisotropic nanoparticles of claim 1, wherein the semiconductor compound is indium phosphide (InP).

10. The anisotropic nanoparticles of claim 1, wherein the anisotropic nanoparticles have a zinc-blende structure.

11. A method for manufacturing anisotropic nanoparticles, the method comprising:
preparing nanoclusters including group III elements and group V elements;
mixing the nanoclusters with a M¹(C2-C18 alkyl carboxyl) 3 or M¹X₃ solution to prepare a reaction solution (wherein M¹ is a group III element and X is halogen); and
heating the reaction solution to perform a reaction.

12. The method for manufacturing anisotropic nanoparticles of claim 11, wherein the preparing of nanoclusters including group III elements and group V elements is mixing and reacting M¹(C2-C4 alkyl carboxyl)₃, a C6-C16 fatty acid, and a phosphine precursor compound to obtain the nanoclusters.

13. The method for manufacturing anisotropic nanoparticles of claim 11, wherein the preparing of a reaction solution is mixing the nanoclusters with a M¹(C6-C16 alkyl carboxyl)₃ solution to prepare the reaction solution, and the anisotropic nanoparticles have a branched structure.

14. The method for manufacturing anisotropic nanoparticles of claim 11, wherein the preparing of a reaction solution is mixing the nanoclusters with a M¹(C2-C4 alkyl carboxyl)₃ solution to prepare the reaction solution, and the anisotropic nanoparticles have a hyperbranched or dendritic structure.

15. The method for manufacturing anisotropic nanoparticles of claim 11, wherein the preparing of a reaction solution is mixing the nanoclusters with a M¹X₃ solution to prepare the reaction solution, and the anisotropic nanoparticles are an aggregate having an irregular needle-shaped surface.
